(19) United States
(12) Patent Application Publication
(10) Pub. No.: US 2015/0324438 A1
(43) Pub. Date: Nov. 12, 2015

(54) RULES BASED UNIVERSAL FORMAT PRESENTATION CONTENT TRANSLATION

(71) Applicant: Viscira, LLC, San Francisco, CA (US)

(72) Inventors: David Gulezian, San Francisco, CA (US); Nathaniel Anthony Fast, Santa Rosa, CA (US); Richard Turner Barker, Piedmont, CA (US)

(73) Assignee: Viscira, LLC, San Francisco, CA (US)

(21) Appl. No.: 14/274,072

(22) Filed: May 9, 2014

(51) Int. Cl. G06F 17/30; H04L 29/08

(52) U.S. Cl. CPC G06F 17/30592; H04L 67/02; H04L 67/10

(57) ABSTRACT

Systems and methods for translating universal formation presentation content translation according to rules. Universal formation presentation content is generated from source content. Presentation rules for the source content are determined. Specific format presentation content is generated from the universal format presentation content by generating at least one key frame of the specific format presentation content from the universal format presentation content. The at least one key frame of the specific format presentation content is used for presenting content of the at least one key frame. At least one action specifying how a user can interact with the content in the at least one key frame is embedded into the at least one key frame based on the presentation rules of the source content.

### BACKGROUND

An area of ongoing research and development is translating content from a source format into a format that is desired by a specific user. Further problems arise in translating content from a source format into a format that is desired by a specific user when a creator of the content or an authority of the content wishes to set limits to the ways in which users can interact with the content, including editing the content. There therefore exists a need for new and improved techniques for translating source content into a specific format that is desired by a user while still limiting how the user can interact with the content.

Other limitations of the relevant art will become apparent to those of skill in the art upon a reading of the specification and a study of the drawings.

### SUMMARY

The following implementations and aspects thereof are described and illustrated in conjunction with systems, tools, and methods that are meant to be exemplary and illustrative, not necessarily limiting in scope. In various implementations one or more of the above-described problems have been addressed, while other implementations are directed to other improvements.

Various implementations include systems and methods for translating universal formation presentation content translation according to rules. In various implementations, universal formation presentation content is generated from source content. In various implementations, presentation rules for the source content are determined. Further, in various implementations, specific format presentation content is generated from the universal format presentation content by generating at least one key frame of the specific format presentation content from the universal format presentation content. In various implementations, the at least one key frame of the specific format presentation content is used for presenting content of the at least one key frame. Additionally, in various implementations, at least one action specifying how a user can interact with the content in the at least one key frame is embedded into the at least one key frame based on the presentation rules of the source content.

These and other advantages will become apparent to those skilled in the relevant art upon a reading of the following descriptions and a study of the several examples of the drawings.

### BRIEF DESCRIPTION OF THE DRAWINGS

FIG. 1 depicts a diagram of an example of a system for generating for generating specific format presentation content from universal format presentation content generation system created from source content.

FIG. 2 depicts a diagram of an example of a system for generating universal format presentation content from source content.

FIG. 3 depicts a diagram of an example of a universal format presentation content data structure.

FIG. 4 depicts a diagram of an example of a system for generating specific format presentation context from universal format presentation content.

FIG. 5 depicts a diagram of an example of a system for translating universal format presentation content to specific format presentation content.

FIG. 6 depicts a flowchart of an example of a method for generating specific format presentation content that includes key frames form source content.

FIG. 7 depicts a flowchart of another example of a method for generating key frames included as part of specific format presentation content from universal format presentation content.

FIG. 8 depicts a flowchart of an example of a method of generating key frames that include hotspots, as part of specific format presentation content, from universal format presentation content.

FIG. 9 depicts a diagram of an example of source content that is converted to specific format presentation content according to presentation rules for the source content.

### DETAILED DESCRIPTION

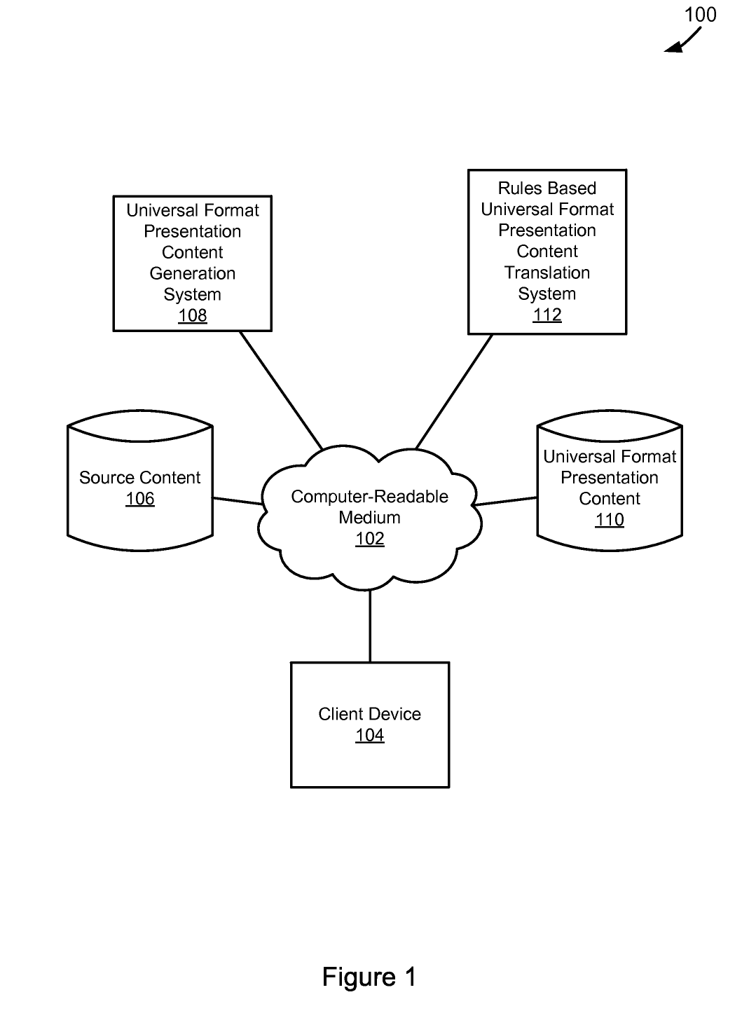

FIG. 1 depicts a diagram 100 of an example of a system for generating for generating specific format presentation content from universal format presentation content generation system created from source content. The system of the example of FIG. 1 includes a computer-readable medium 102, a client device 104, a source content datastore 106, a universal format presentation content generation system 108, a universal format presentation content datastore 110, and a rules based universal format presentation content translation system 112.

The client device 104, the source content datastore 106, the universal format presentation content generation system 108, the universal format presentation content datastore 110, and the rules based universal format presentation content translation system 112 are coupled to each other through the computer-readable medium 102. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the client device 104, the universal format presentation content generation system 108, the rules based universal format presentation content translation system and other applicable systems, or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes at least two components: 1) a dedicated or shared processor and 2) hardware, firmware, and/or software modules that are executed by the processor. Depending upon implementation-specific or other considerations, an engine can be centralized or its functionality distributed. An engine can include special purpose hardware, firmware, or software embodied in a computer-readable medium for execution by the processor. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

In a specific implementation, the client device 104 can be an applicable device through which a user can send and receive data through a network. In sending and receiving data a user can receive specific format presentation content, or support a player through which the user can interact with specific format presentation content. Further, the client device 104 can include a graphical user interface through which a user can interact with specific format presentation content. As used in this paper, interacting with specific format presentation content can include: a user viewing presentation content, presenting presentation content, and/or editing presentation content. Depending upon implementation-specific or other considerations, the client device 104 can include a wireless interface through which the client device 104 can form a wireless connection to the computer-readable medium 102. Further depending upon implementation-specific or other considerations, the client device 104 can be a thin client or an ultra-thin client.

In a specific implementation, the source content datastore 106 functions to store source content used in generating presentation content. Presentation content can include applicable content that can be presented to a viewer, such as images, videos, stills, and/or slide presentations. Depending upon implementation-specific or other considerations, source content stored in the datastore 106 can be used creating in universal format presentation content and specific format presentation content. As used in this paper, universal format presentation content includes content in a format that is not specific to a specific protocol or a specific application. For example, if universal format presentation content is generated form a PowerPoint® presentation, then the universal format presentation content is universal in that it does not need to be viewed using an application capable of playing a PowerPoint® presentation. As used in this paper, specific formation presentation content includes content that is in a format specific to a protocol or an application. For example, source content stored in the source content datastore 204 can be a PowerPoint® presentation and therefore specific to an application that supports execution of a PowerPoint®. In another example, source content stored in the source content datastore 204 can be a QuickTime® video.

In a specific implementation, the universal format presentation content generation system 108 functions to generate universal format presentation content from source content. In generating universal format presentation content from source content, the universal format presentation content generation system 108 can translate content from source content into presentation content in a universal format in a content layer of universal format presentation content. Further in generating universal format presentation content from source content, the universal format presentation content generation system 108 can include or embed actions for presentation in a universal format of the universal format presentation content. Actions embedded or otherwise included by the universal format presentation content generation system 108 in universal format presentation content can specify or limit how a user views, presents, and modifies universal format presentation content and/or specific format presentation content generated from the universal format presentation content.

In a specific implementation, the universal format presentation content generation system 108 functions to generate universal format presentation content according to presentation rules of the source content. Presentation rules can include rules that specify how a user can view, modify, and/or present source content either as universal format presentation content or specific format presentation content. Presentation rules can also specify how source content is grouped into subsets of content for use in generating specific format presentation content. Presentation rules can be determined directly from source content or directly from an authority of creator of source content, using an applicable system for determining presentation rules, such as the universal format presentation content generation system 108. In generating universal format presentation content according to presentation rules of the source content, the universal format present content generation system 108 can create subsets of universal format presentation content, e.g. a plurality of different content layer, corresponding to subsets of content, as indicated by presentation rules.

In a specific implementation, in generating universal format presentation content according to presentation rules of the source content, the universal format presentation content generation system 108 functions to include or embed actions into the universal format presentation content based on the presentation rules. For example, if presentation rules specify that a user is not allowed to modify specific source content, then the universal format presentation content generation system 108 can embed or include an action into the universal format presentation content indicating that parts of the universal format presentation content that include the specific content is read-only.

In a specific implementation, the universal format presentation content datastore 110 functions to store universal format presentation content. Universal format presentation content stored in the universal format presentation content datastore 110 can be generated from source content stored in the source content datastore 106 by the universal format presentation content generation system 108.

In a specific implementation, the rules based universal format presentation content translation system 112 functions to generate specific format presentation content from universal format presentation content. In generating specific format presentation content from universal format presentation content, the rules based universal format presentation content translation system 112 can determine a specific format to translate universal format presentation content to in creating specific format presentation content. Depending upon implementation-specific or other considerations, the rules based universal format presentation content translation system 112 can determine a specific content to translate universal format presentation content to either directly from a user, or from applications or characteristics of a client device used by the user. Examples of specific content types that the rules based universal format presentation content translation system 112 can translate universal format presentation content to include but not are limited to: HTML, HTML 5, PowerPoint®, Adobe PDF®, and ePub. Depending upon implementation-specific or other considerations, in translating universal format presentation content into specific format presentation content, the rules based universal format presentation content translation system 112 can generate key messages that are included as part of the specific format presentation content, such as a VEEVA® Customer Relationship Management (CRM) key message format. A disadvantage of CRM solutions, however, is they support one type of rule, the “predecessor rule;” there is no grouping, mandatory/optional presentations sequences, etc. So “custom” presentation is unbounded, allowing removal of slides, reordering.

Key messages generated by the rules based universal format presentation content translation system 112 can define what content in one or a plurality of subsets of specific format presentation content, e.g. one of a plurality of content layers, is presented to a user and how the content is presented to a user. The content is bounded and supports multiple modes of inclusion/exclusion, fixed/flexible placement, and other features described in this paper. Advantageously, users, such as by way of example but not limitation sales representatives, can be given as much control as they are allowed with pre-authored content.

In a specific implementation, the rules based universal format presentation content translation system 112 functions to translate universal format presentation content into specific format presentation content according to presentation rules of source content from which the universal format presentation content is created. For example, the rules based universal format presentation content translation system 112 can group content in universal based presentation format content into subsets of specific format presentation content, e.g. content layers, according to presentation rules that specify which source content should be grouped together into subsets. In another example, the rules based universal format presentation content translation system 112 can include actions in subsets of specific format presentation content that specify which subset of specific format presentation content to present next according to presentation rules that specify subsets of source content that should be presented after each other. Depending upon implementation-specific or other considerations, the rules based universal format presentation content translation system 112 can use presentation rules for source content determined by the universal format presentation content translation system 112. Further depending upon implementation-specific or other considerations, the rules based universal format presentation content translation system 112 can determine presentation rules from either or both source content or universal format presentation content created from the source content.

In a specific implementation, the rules based universal format presentation content translation system 112 can translate universal format presentation content into specific format presentation content based on relations between subsets of the specific format presentation content. For example, if there is a chance or a likelihood that a user will view a second subset of specific format presentation content after viewing a first subset of specific format presentation content, then the rules based universal format presentation content translation system 112 can include an action in the first subset that specifies to present the second subset after the first subset is presented to a user.

In a specific implementation, in translating universal format presentation content into specific format presentation content according to presentation rules of source content, the rules based universal format presentation content translation system 112 can manage hotspots in the specific format presentation content. In managing hotspots in the specific format presentation content, the rules based universal format presentation content generation system 108 can add hotspots and associate specific actions with activation of a hotspot. Actions associated with a hotspot can include actions related to presentation, viewing, or manipulation of specific format presentation content. Depending upon implementation-specific or other considerations, the rules based universal format presentation content translation system 112 can manage hotspots in specific format presentation content according to presentation rules of source content from which the specific format presentation content is ultimately created.

In an example of operation of the example system shown in FIG. 1, the client device 104 functions to send and receive data used by a user in interacting with specific format presentation content. In the example of operation of the example system shown in FIG. 1, universal format presentation content generation system 108 generates specific format presentation content from source content stored in the source content datastore 106. Further in the example of operation the rules based universal format presentation content translation system 112 generates specific format presentation content from universal format presentation content stored in the universal format presentation content datastore 110 based on presentation rules of source content from the universal format presentation content was created.

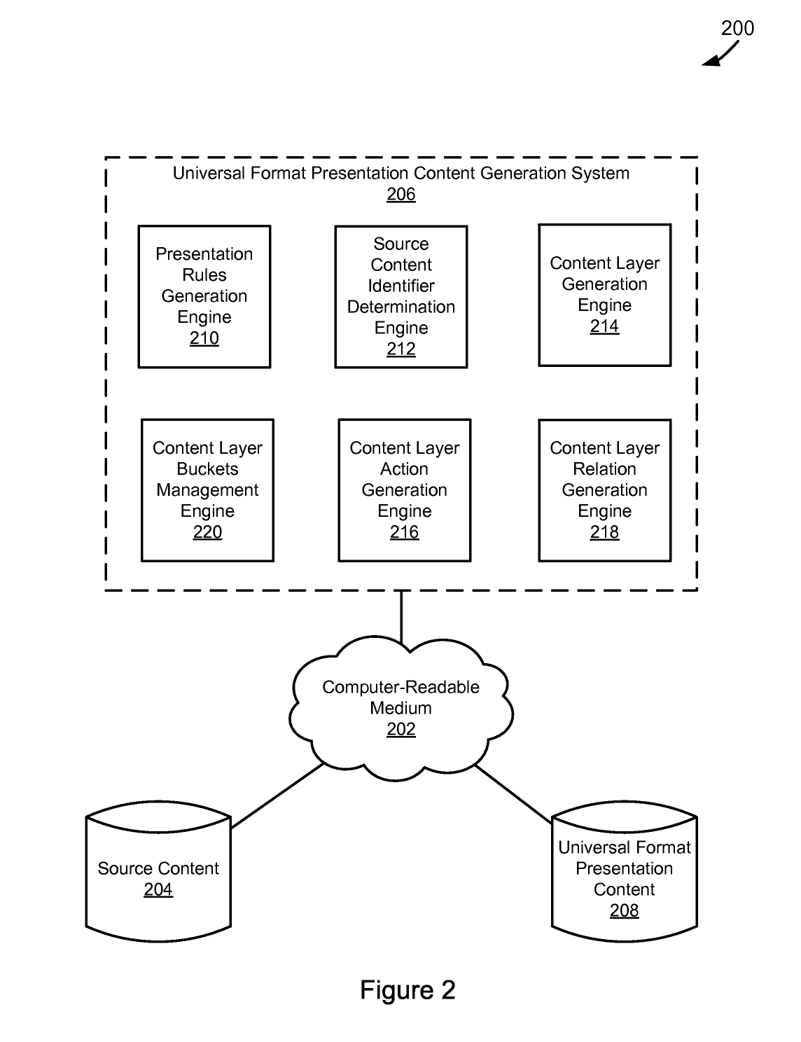

FIG. 2 depicts a diagram 200 of an example of a system for generating universal format presentation content from source content. The example system of FIG. 2 includes a computer-readable medium 202, a source content datastore 204, a universal format presentation content generation system 206, and a universal format presentation content datastore 208. In the example system shown in FIG. 2, the source content datastore 204, the universal presentation content generation system 206, and the universal format presentation content datastore 208 are coupled to each other through the computer-readable medium 202.

In a specific implementation, the source content datastore 204 functions according to an applicable datastore for storing source content that is used in generating presentation content, such as the source content datastores described in this paper. Source content stored in the source content datastore 204 can have presentation rules associated with it. Presentation rules can include rules that specify how a user can view, modify, and/or present source content. Presentation rules can specify how source content is grouped into subsets of content. Depending upon implementation-specific or other considerations, presentation rules can includes rules that specify how a user can view, modify, and/or present source content after it is translated into a universal format presentation content, and/or specific format presentation content. For example, presentation rules can specify that a user is not allowed to add specific language to the source content, universal presentation content, and/or specific format presentation content. Presentation rules can be included as part of source content stored in the source content datastore 204 or received on-demand from a creator or an administrator of the source content.

In a specific implementation, the universal format presentation content generation system 206 functions according to an applicable system for generating universal format presentation content form source content, such as the universal format presentation content generation systems described in this paper. The universal format presentation content generation system 206 can generate universal format presentation content in accordance with presentation rules of the source content form which the universal format presentation content is generated. For example, if presentation rules for the source content, specific that specific content of the source content, e.g. a document or slide in the source content, cannot be deleted from the source content, then the universal format presentation content generation system 206 can embed an action in universal format presentation content created from the source file that prohibits the deletion of the specific content form the universal format presentation content, or specific format presentation created therefrom.

The universal format presentation content datastore 208 functions to an applicable datastore for storing universal format presentation content, such as the universal format presentation content datastores described in this paper. The universal format presentation content datastore 208 can store universal format presentation content generated by the universal format presentation content generation system 206 from source data stored in the source content datastore 204. Universal format presentation content stored in the universal format presentation content datastore 208 can include presentation rules for source content, and or embedded actions created in response to the presentation rules for the source content, from which the universal formation presentation content is created.

In the example system shown in FIG. 2, the universal format presentation content generation system 206 includes, a presentation rules generation engine 210, a source content identifier determination engine 212, a content layer generation engine 214, a content layer action generation engine 216, a content layer relation generation engine 218, and a content layer buckets management engine 220.

In a specific implementation, the presentation rules generation engine 210 functions to determine presentation rules for source content from which universal format presentation content is generated. Depending upon implementation-specific or other considerations, the presentation rules generation engine 210 can determine presentation rules for source content directly from the source content. Further depending upon implementation-specific or other considerations, the presentation rules generation engine 210 can determine presentation rules from a creator of source content or an administrator for the source content. For example, the presentation rules generation engine 210 can query a creator or an administrator of source content for presentation rules of the source content.

In a specific implementation, the source content identifier determination engine 212 functions to determine an identifier of source content that is used to generate universal format presentation content. Depending upon implementation-specific or other considerations, an identifier of source content determined by the source content identifier determination engine 212 can be an identifier of a user, role, or group that granted the approval of the source content, the date an approval of the source content was granted, or the like. Further depending upon implenetation-specific or other considerations, an identifier of source content determined by the source content identifier determination engine 212 can include an identifier of an instance of universal format presentation content or specific format presentation content generated from the universal format presentation content. An identifier of an instance of specific format presentation content generated from the universal format presentation content can be received from a user modifying the specific format presentation content generated from the universal format presentation content.

In a specific implementation, the content layer generation engine 214 functions to generate content and content layers that include the content using source content. In generating content and content layers for the content, the content layer generation engine 214 can convert content that is included as part of source data into universal format presentation content that can be converted into specific formation presentation content. For example, the content layer generation engine 214 can generate content from source content that is a PowerPoint® file into universal format presentation content. Depending upon implementation-specific or other considerations, the content layer generation engine 214 can generate content layers that can include image, video, text, mask, or the like.

In a specific implementation, in creating content layers of universal format presentation content, the content layer generation engine 214 can group source content into a subset of content that forms a content layer or group of content layers. Depending upon implementation-specific or other considerations, in grouping source content into a subset of content, the content layer generation engine 214 can group content that is related, e.g. is part of the same sequence of content or is of the same type of content, into the subset of content. Further depending upon implementation-specific or other considerations, in grouping source content into a subset of content, the content layer generation engine 214 can group content into the subset of content based on presentation rules for the source content. For example, if presentation rules specify that a portion of a video should be grouped into a specific subset of content, then the content layer generation engine 214 can group the portions of the video into the specific subset of content.

In a specific implementation, the content layer action generation engine 216 functions to embed or otherwise include actions for specific content layers in universal format presentation content. Actions embedded or otherwise included by the content layer action generation engine 216 can specify or limit how a user views, presents, and modifies universal format presentation content and/or specific format presentation content generated from the universal format presentation content. The content layer action generation engine 216 can generate actions based on presentation rules for universal format presentation content determined by the presentation rules generation engine 210. For example, if presentation rules specify that a user is not allowed to modify specific content of source content, then the content layer action generation engine 216 can embed or include an action into a content layer that includes the specific content that specifies or causes the specific content in the content layer to be read-only.

In a specific implementation, the content layer relation generation engine 218 functions to determine relations between content layers included in universal format presentation content. Relations between content layers determined by the content layer relation generation engine 218 can include that content in content layers should be presented sequentially or that a user might want to view the content in two content layers simultaneously. Depending upon implementation-specific or other considerations, the content layer relation generation engine 218 can determine how content layers are related based on a specific probability that a user will view the content layers sequentially or within a specific amount of time or a specific number of viewed content layers.

In a specific implementation, the content layer buckets management engine 220 functions to group content layers generated by the content layer generation engine 214 into buckets. The content layer buckets management engine 220 can group content layers into buckets based on relations between content layers, as determined by the content layer relation generation engine 218. The content layer buckets management engine 220 can classify buckets into which content layers are grouped. The content layer buckets management engine 220 can classify buckets based on the content layers that are grouped into the bucket or the presentation rules for the source content, from which the content layers in the bucket were created. Depending upon implementation-specific or other considerations, the content layer buckets management engine 220 can remove or add content layers to a bucket during or after a user interacts with specific format presentation content generated form the universal format presentation content.

In an example of operation of the example system shown in FIG. 2, the presentation rules generation engine 210 determines presentation rules of source content stored in the source content datastore 204 from which universal format presentation content is created. In the example of operation of the example system shown in FIG. 2, the source content identifier determination engine 212 generates an identifier for the universal format presentation content generated from the source content. Further, in the example of operation of the example system shown in FIG. 2, the content layer generation engine generates content layers that form the universal format presentation content generated from the source content. In the example of operation of the example system shown in FIG. 2, the content layer action generation engine determines and embeds or includes actions for content layers in the universal format presentation content based on presentation rules of the source content determined by the presentation rules generation engine 210. Additionally, in the example of operation of the example system shown in FIG. 2, the content layer relation generation engine 218 determines the relations between content layers in the universal format presentation content. In the example of operation of the example system shown in FIG. 2, the content layer buckets management engine 220 ads the content layers into buckets based on the relations between content layers determined by the content layer relation generation engine 218.

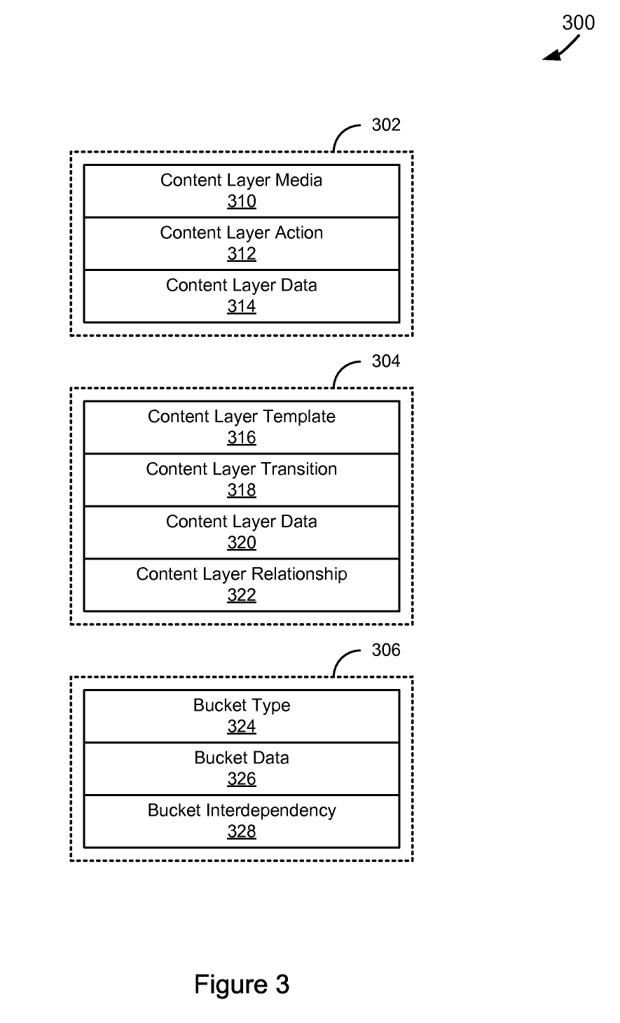

FIG. 3 depicts a diagram 300 of an example of a universal format presentation content data structure. In the example of FIG. 3, the universal format presentation content data structure includes a layer super-structure 302, a content layer super-structure 304, and a group super-structure 306. The term “super-structure” is used to cover a category of items that may or may not be referred to in a specific implementation as a record, object, or some other collection of items. In a specific implementation, each of the super-structures 302-306 has an explicit identifier (not shown) that uniquely refers to instances of the super-structures 302-306. Alternatively, the super-structures 302-306 may be conceptual organizations of data that do not have explicit identifiers.

In the example of FIG. 3, the layer super-structure 302 includes a content layer media structure 310, a content layer action structure 312, and a content layer data structure 314. The content layer media structure 310 can include image, video, text, mask, or the like. The content layer media structure 310 can include content that is grouped into a subset of content, as specified by presentation rules for source content.

The content layer action structure 312 can include actions that can be taken on content layer media, such as slide, fade, dissolve, or the like. Actions included in the content layer action structure 312 can be determined from presentation rules for source content, from which a content layer is generated. Applicable actions can vary depending upon the type of content that is being displayed (e.g., image, video, and text may have slightly or significantly different applicable actions). Applicable actions can be added as needed or desired. The actions can be stored as pointers, variables, functions, methods (e.g., within an object), or in some other applicable manner. In a specific implementation that relates to the visual animation of layer media, the content layer action structure 312 can be referred to as including a layer animation structure. Colloquial distinctions between media and animation can be blurred in some cases. For example, an item of content, such as a bullet point, could be animated to fly into a slide with a “whooshing” sound. The bullet point would obviously be characterized as media, the animation flying the bullet point into the slide animation, but reasonable minds could differ about whether the “whooshing” sound is media or animation. For the purposes of this paper, the former definition is assumed. That is, the media file that contains the “whooshing” sound is defined as layer media.

The content layer data structure 314 can include a Z-ordered set of layers. The content layer data structure 314 includes data about each layer in the appropriate order.

In the example of FIG. 3, the content layer super-structure 304 includes a content layer template structure 316, a content layer transition structure 318, a content layer data structure 320, and a content layer relationship structure 322. The content layer template structure 316 can include a layout basis for content.

The content layer transition structure 318 can include data sufficient to determine how content transitions to a next content during presentation of content. The transition can depend upon a transition type, such as standard, video, agenda, or some other descriptor for a type of content.

The content layer data structure 320 can include notes for a speaker or master of ceremonies or content descriptions, such as leaf node, title, ID, version, or the like that are descriptive of content. The content layer data structure 320 includes data that essentially points to an entire, complete slide, as opposed to data that is directed to a more granular content item within content.

The content layer relationship structure 322 can include data about how specific content is ordered with relation to one another. In a specific implementation, this data can be referred to as “n of X” data to represent how a specific content, n, falls within the organization of all content, X, in universal format presentation content. Depending on the technology, content could have a more complex relationship than “n of X,” such as when content is essentially in a tree with multiple conditional branches. However, it is expected that, due to the nature of presentations in general, the “n of X” relationship may be adequate, with branches being treated as exceptions.

In the example of FIG. 3, the group super-structure 306 includes a bucket type structure 324, a bucket data structure 326, and a bucket interdependency structure 328. “Bucket” is a convenient term to describe a plurality of content layers. The bucket type structure 324 can identify a set of rules applicable to the bucket. Bucket types can include optional (the slides can be removed, if desired), permutable (the slides can be presented in any order), following (the slides must follow one another in an indicated order), grouped (the slides must be presented together), locked (the slides must be presented together in a specific order), to name several examples. The bucket type can be indicative of other use rules related to a given bucket.

The bucket data structure 326 can include data about a bucket. In order to enable interdependency between buckets, each bucket can be identifiable to enable ordering within a deck. Thus, the bucket data structure 326 will generally at least include a bucket identifier or address.

The bucket interdependency structure 328 can include a set of rules and fields related to how content can be presented with respect to one another. Bucket interdependency can include locked (one bucket must immediately follow another bucket), following (one bucket must follow another bucket), flexible (either bucket must follow the other), none (a bucket has no interdependencies and can be deleted if desired), to name several examples. In a specific implementation, the interdependency data is associated with approvals, with deviations from the interdependencies resulting in the approval being rescinded (assuming the system even allows users to deviate).

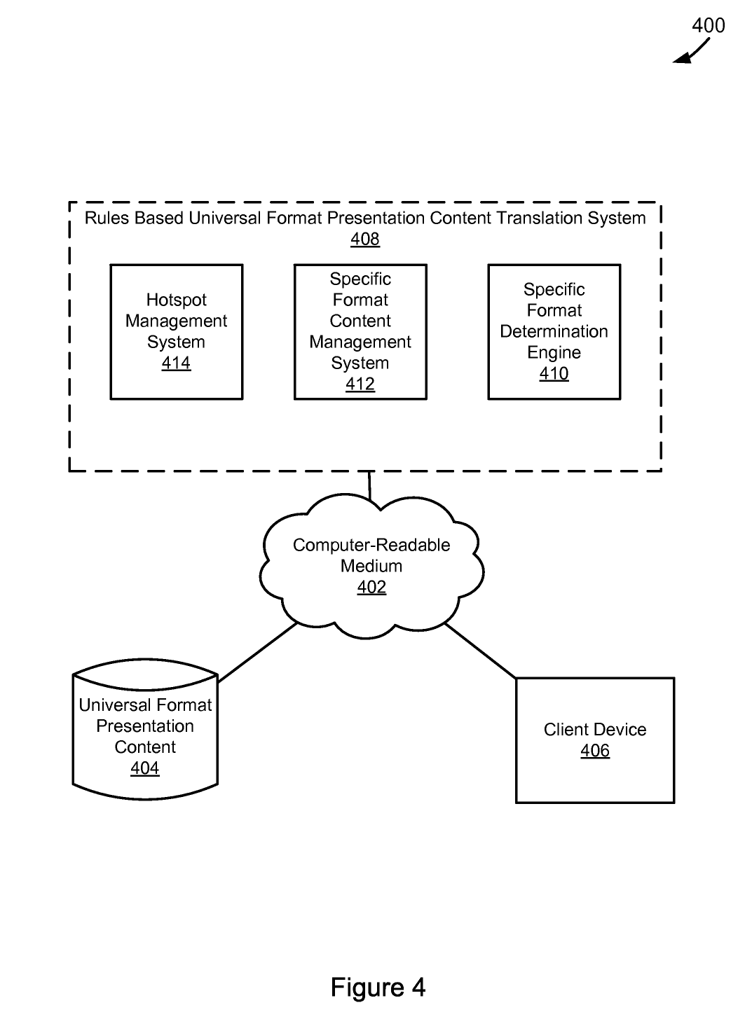

FIG. 4 depicts a diagram 400 of an example of a system for generating specific format presentation context from universal format presentation content. The example system shown in FIG. 4 includes a computer-readable medium 402, a universal format presentation content datastore 404, a client device 406, and a rules based universal format presentation content translation system 408. In the example system shown in FIG. 4, the universal format presentation content datastore 404, the client device 406, and the rules based universal format presentation content translation system 408 are coupled to each other through the computer-readable medium 402.

In a specific implementation, the universal format presentation content datastore 404 functions according to an applicable datastore for storing universal format presentation content, such as the universal format presentation content datastores described in this paper. Universal format presentation content stored in the universal format presentation content datastore 404 can be formatted according to a data structure described in this paper. Additionally, universal format presentation content stored in the universal format presentation content datastore 404 can include actions that specify or limit presentation or editing of the universal format presentation content or specific format presentation content created from the universal format presentation content.

In a specific implementation, the client device 406 functions according to an applicable device for receiving specific format presentation content, such as the client devices described in this paper. Through the client device 406 a user can specify a specific format in which they want to receive source content. For example, if the user wants to receive the source content in HTML 5 format, then the user can specify through the client device 406 that they want the source content in HTML 5. Additionally, the client device 406 can include a player that allows a user of the client device 406 to interact with presentation content in a specific format. A player implemented on the client device 406 can include functionalities for ensuring that a user interacts with content according to presentation rules for the source content. For example, a player can treat a specific portion of content as read-only and disable editing functions when a user interacts with the specific portion of content.

In a specific implementation, the rules based universal format presentation content translation system 408 functions to translate universal format presentation content to specific format presentation content. The rules based universal format presentation content translation system 408 can translate universal format presentation content stored in the universal format presentation content datastore 404 into specific format presentation content. The rules based universal format presentation content translation system 408 can translate universal format presentation content into a specific format that a user requests. Examples of specific formats of presentation content that the rules based universal format presentation content translation system 408 can translate universal format presentation content to include but are not limited to: HTML, HTML 5, PowerPoint®, Adobe PDF®, and ePub. In translating universal format presentation content to specific format presentation comment, the rules based universal format presentation content translation system, and applicable systems or engines associated with or included as part of the rules based universal format presentation content translation system 408 can determine presentation rules for source content from which the universal format presentation content is created. Depending upon implementation-specific or other considerations, the rules based universal format presentation content translation system, and applicable systems or engines associated with or included as part of the rules based universal format presentation content translation system 408 can determine presentation rules for source content from the source content directly or from an authority or a creator of the source content.

In the example system shown in FIG. 4, the rules based universal format presentation content translation system 408 includes a specific format determination engine 410, a specific format content management system 412, and a hotspot management system 414. In a specific implementation, the specific format determination engine 410 functions to determine a specific format in which a user wants to receive presentation content generated from universal format presentation content. The specific format determination engine 410 can determine a specific format by querying a user or receiving input from a user indicating the specific format.

In a specific implementation, the specific format content management system 412 functions to translate universal format presentation content into a specific format. The specific format content management system 412 can translate universal format presentation content stored in the universal format presentation content datastore 404 into a specific format determined by the specific format determination engine 410. In translating universal format presentation content into specific format presentation content, the specific format presentation content management system 412 can translate the specific format presentation content according to presentation rules of source content from which the universal format presentation content was generated. Additionally, in translating universal format presentation content into specific format presentation content, the specific format content management system 412 can embed or include actions in the specific format presentation content that are embedded or included in the universal format presentation content based on presentation rules. For example, if an action in the universal format presentation content indicates that specific content is not to be edited, then the specific format content management system 412 can include the action in specific format presentation content generated form the universal format presentation content.

In a specific implementation, the specific format content management system 412 generates key frames that are included as part of specific format presentation content. Depending upon implementation-specific or other considerations, the specific format content management system 412 can generate key frames if the specific format determination engine 410 determines that a specific format is HTML 5. In generating key frames to create specific format presentation content, how content is presented can be defined. For example, a key frame can specify to show a first slide and then a second slide in a PowerPoint® presentation that serves as source content. In another example, a key frame can specify to show a first video and then a second video after the first video. Key frames generated by the specific format content management system 412 can specify both where in a presentation and when in a presentation to display specific content. Key frames included as part of specific format presentation content can be created by the specific format content management system 412 in accordance with presentation rules for source content used to generate universal format presentation content from which the specific format presentation content is created. For example, if presentation rules specify that slide A has to be shown after slide B, then a key message can be created that instructs slide A to be shown after slide B. Similarly, if presentation rules specify that images A and B have to be shown simultaneously, then a key message can be created that instructs that images A and B be shown simultaneously.

In a specific implementation, the hotspot management system 414 functions to manage hotspots in specific format presentation content. A hotspot, as used in this paper, is a region of presented content that a user can activate to perform a specific action. In managing hotspots, the hotspot management system 414 can create hotspots in presentation content included as part of specific format presentation content. In creating hotspots in specific format presentation content, the hotspot management system 414 can embed actions associated with a hotspot in a created hotspot. For example, the hotspot management system 414 can create a hotspot and embed a hotspot that specifies to display next content when the hotspot is activated.

In a specific implementation, the hotspot management system 414 manages hotspots in specific format presentation content according to presentation rules of source content from which the specific format presentation content was ultimately created. For example, if presentation rules specify to display slide B after slide A, then the hotspot management system 414 can generate a hotspot in slide A that when activated, slide B is presented. Depending upon implementation-specific or other considerations, the hotspot management system 414 can generate hotspots in key frames generated by the specific format content management system 412 based on presentation rules. For example, the hotspot management system 414 can include a hotspot in a key frame for slide A that presents slide B if it is activated if presentation rules specify that slide B should be shown after slide A.

In an example of operation of the example system shown in FIG. 4, the specific format determination engine 410 functions to determine a specific format for a user of the client device 406. In the example of operation, the specific format content management system 412 translates universal format presentation content stored in the universal format presentation content datastore 404 into specific format presentation content. Further in the example of operation of the example system shown in FIG. 4, the specific format content management system 412 functions to generate specific format content from universal format presentation content according to a specific format determine by the specific format determination engine 410. In the example of operation of the example system shown in FIG. 4, the hotspot management system 414 functions to generate hotspots for specific format content generated from universal format presentation content.

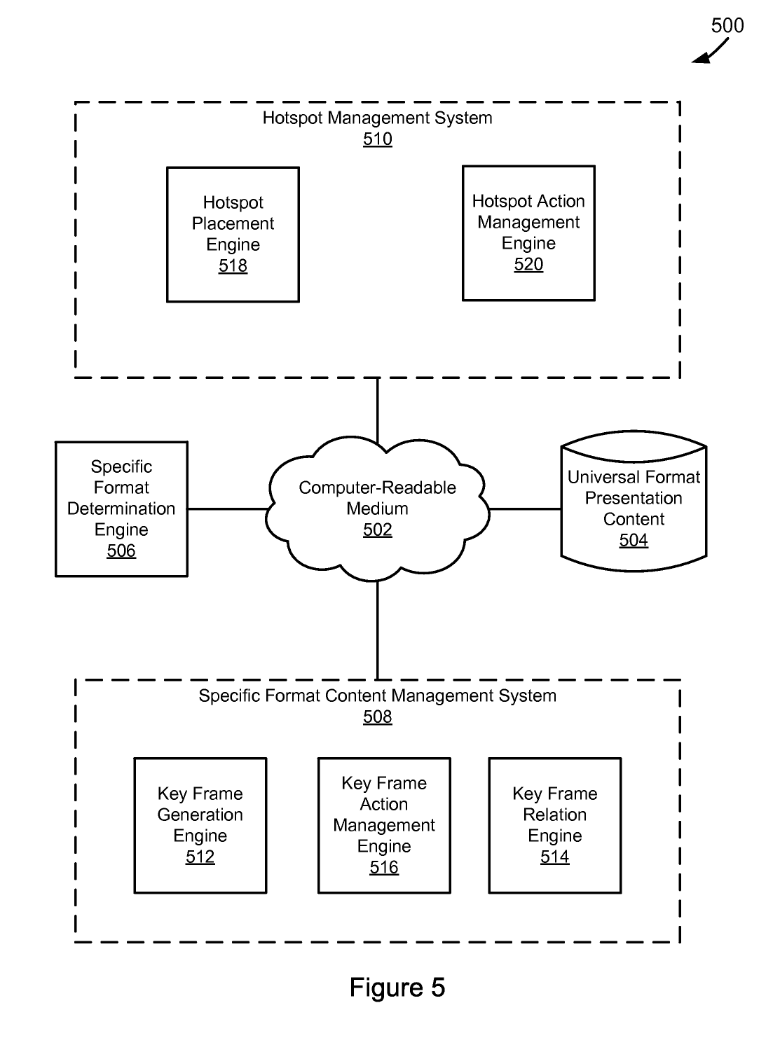

FIG. 5 depicts a diagram 500 of an example of a system for translating universal format presentation content to specific format presentation content. The example system shown in FIG. 5 includes a computer-readable medium 502, a universal format presentation content datastore 504, a specific format determination engine 506, a specific format content management system 508, and a hotspot management system 510. In the example system shown in FIG. 5, the universal format presentation content datastore 504, the specific format determination engine 506, the specific format content management system 508, and the hotspot management system 510 are coupled to each other through the computer-readable medium 502.

In a specific implementation, the universal format presentation content datastore 504 functions according to an applicable datastore for storing universal format presentation content, such as the universal format presentation content datastores described in this paper. Universal format presentation content stored in the universal format presentation content datastore 504 can be formatted according to a data structure described in this paper. Additionally, universal format presentation content stored in the universal format presentation content datastore 504 can include actions that specify or limit presentation or editing of the universal format presentation content or specific format presentation content created from the universal format presentation content.

In a specific implementation, the specific format determination engine 506 functions according to an applicable system for determining a specific format to translate universal format content to for use by a user, such as the specific format determination engines described in this paper. The specific format determination engine 506 can determine a specific format to translate universal format content to by querying a user of a client device to determine the specific format. The specific format determination engine 506 can also determine a specific format to translate universal format content to by determining applications or systems specifications of a device used by a user to determine what specific formats are supported on the device. Examples of specific formats determined by the specific format determination engine 506 include, but are not limited to: HTML, HTML 5, PowerPoint®, Adobe PDF®, and ePub.

In a specific implementation, the specific format content management system 508 functions according to an applicable system for translating universal format presentation content to a specific presentation format, such as the specific format content management systems described in this paper. In translating universal format presentation content to specific format presentation content, the specific format content management system can translate universal format presentation content stored in the universal format presentation content datastore 504 to presentation content of a specific format, as determined by the specific format determination engine 506. In translating universal presentation format content to specific format presentation content, the specific format content management system 508 can translate the specific format presentation content according to presentation rules of source content from which the universal format presentation content was generated. For example, if presentation rules specify that a second subset of source content has to be shown after a first subset of source content is shown, then the specific format content management system 508 can embed an action into a first subset of the specific format presentation content that includes the first subset of source content that a second subset of the specific format presentation content that includes the second subset of source content should be shown after the first subset of the specific format presentation content is shown. In another example, if presentation rules specify that a first subset of source content should be read-only, then the specific format content management system 508 can embed an action into a first subset of specific format presentation content that includes the first subset of source content, that locks the first subset of specific format presentation content from editing by a user.

In a specific implementation, the hotspot management system 510 functions according to an applicable system for generating and managing hotspots in specific format presentation content, such as the hotspot management systems described in this paper. In managing hotspots, the hotspot management system 510 can place hotspots in translated specific format presentation content. Further, in managing hotspots, the hotspot management system 510 can determine one or a plurality of actions associated with a hotspot placed in translated specific format presentation content. Actions associated with a hotspot can be actions that are performed on specific format presentation content when the hotspot is activated. For example, the hotspot management system 510 can associate actions with a hotspot that slows down specific format presentation content when the hotspot is activated. The hotpot management system 510 can generate hotspots specific to subsets of specific format presentation content and/or associate specific actions to subsets of specific format presentation content. For example, the hotspot management system 510 can associate different actions to hotspots in a first key frame and a second key frame that are included as part of specific format presentation content. Depending upon implementation-specific or other considerations, the hotspot management system 510 can generate and hotspots and associate actions to hotspots based on presentation rules of source content from which specific format presentation content is ultimately created.

In the example system shown in FIG. 5, the specific format content management system 508 includes a key frame generation engine 512, a key frame relation engine 514, and a key frame action management engine 516. In a specific implementation, the key frame generation engine 512 functions to generate key frames of universal format presentation content, to generate, at least in part, specific format presentation content. Depending upon implementation-specific or other considerations, the key frame generation engine 512 can generate key frames if the specific format determination engine 506 determines that a specific format to translate universal format presentation content to is HTML 5.

In a specific implementation, in generating key frames, the key frame generation engine 512 can generate one or a plurality of key frames from universal format presentation content grouped into a subset of source content or a subset of universal format presentation content. Depending upon implementation-specific or other considerations, in generating one or a plurality of key frames, the key frame generation engine 512 can group universal format presentation content or source content into a subset of content. In grouping universal format presentation content or source content into a subset of content, the key frame generation engine 512 can group content that is related, e.g. is part of the same sequence of content or is of the same type of content, into the subset of content. Further depending upon implementation-specific or other considerations, the key frame generation engine 512 can generate one or a plurality of key frames from universal format presentation content grouped into a subset of source content or a subset of universal format presentation specified by presentation rules for source content from which specific format presentation content is ultimately created. For example, if presentation rules specify that a portion of a video should be grouped into a specific subset of content, then the key frame generation engine 512 can generate one or a plurality of key frames that play the portion of the video grouped into the specific subset of content.

In a specific implementation, the key frame generation engine 512 can generate new key frames or update already existing key frames as a user interacts with specific format presentation content that includes the key frames. For example, if a user modifies specific content to be displayed to include a first and second segment of video of source content that is represented by corresponding first and second key frames, then the key frame generation engine 512 can merge the first and second key frames into a single key frame. Similarly, if a user wants to delete a portion of a video segment represented by a key frame, then the key frame generation engine 512 can modify the key frame, so that the portion of the video segment is not displayed. Depending upon implementation-specific or other considerations, the key frame generation engine 512 can generate new key frames or update already existing keys according to presentation rules for source content from which specific format presentation content that includes the key frames is ultimately created. For example, if a user wants to display a second video segment after a first video segment, and presentation rules of the first video segment that only a third video segment can be displayed after the first video segment, then the key frame generation engine 512 can determine not to create new key frames or update already existing key frames to cause the second video segment to be displayed after the first video segment.

In a specific implementation, the key frame relation engine 514 can determine relations between key frames. Relations between key frames determined by the key frame relation engine 514 can include that a second key frame should be executed after a first key frame. Additionally, relations between key frames determined by the key frame relation engine 514 can include a likelihood that a user will want to execute a second key frame after a first key frame is executed. Relations between key frames determined by the key frame relation engine 514 can be included as part of a content layer super-structure in a content layer relationship structure. Depending upon implementation-specific or other considerations, the key frame relation engine 514, can determine relations between key frames based on presentation rules of source content that is included in the key frames. For example, if presentation rules specify that a second subset of source content should be displayed after a first subset of source content, then the key frame relation engine 514 can determine that a key frame that includes the second subset of source content should be executed after a key frame that includes the first subset of source content is executed. Further depending upon implementation-specific or other considerations, the key frame relation engine 514, can determine a relation of key frames based on a specific probability that a first key frame will be executed after a second key frame. A specific probability that a first key frame will be displayed after a second key frame can be determined based on whether or the amount of times that users during previous sessions interacted with content included in the second key frame after interacting with content included in the first key frame.

In a specific implementation, the key frame action management engine 516 can include or embed actions in key frames generation by the key frame generation engine 512. Actions included in or embedded into key frames by the key frame action management engine 516 can specify how a user can interacts with key frames. For example actions embedded into key frames by the key frame action management engine 516 can specify that a key frame is read-only and cannot be edited by a user. In another example, actions embedded into a key frame specify what content can be modified in the key frame. The key frame action management engine 516 can include or embed actions into a key frame based on presentation rules for source content that is include in the key frame. For example, if presentation rules for source content included in the key frame specify that the source content should not be modified, then the key frame action management engine 516 can embed or include an action that makes the source content ultimately included in the key frame read-only.

In a specific implementation, the key frame action management engine 516 can embed actions that include what key frames to execute after executing a specific key frame based on relations between key frames determined by the key frame relation engine 514. For example, if the key frame relation engine 514 determines that a second key frame should be executed after a first key frame or that there is a chance that a user will want to execute the second key frame after the first key frame, then the key frame action management engine can include an action in the first key frame that instructs execution of the second key frame after execution of the first key frame.

In the example system shown in FIG. 5, the hotspot management system 510 includes a hotspot placement engine 518, and a hotspot action management engine 520. Hotspots included in key frames, can be visual indicia that are used in interacting with content represented by the key frame. In use in interacting with content, hotspots can be used to manipulate execution of key frames in order to interact with content represented by the key frame. For example, a hotspot can be used to speed up the rate at which a key frame is executed in order to display content represented by the key frame faster. The hotspot placement engine 518 can generate and place hotspots within a key frame based on presentation rules for source content that is included in the key frame. For example, if presentation rules can specify that a hotspot can only be placed in a specific corner of content displayed in executing a key frame, then the hotspot placement engine 518 can place a hotspot in the specific corner of the content displayed in the key frame. Additionally, the hotspot placement engine 518 can place specific hotspots with specific visual indicia according to presentation rules. For example, presentation rules for source content can specify that a hotspot represented by a circle should be placed in a key frame. In another example, if presentation rules for source content can specify that source content represented in a key frame can be edited, then the hotspot placement engine 518 can place hotspots that include indicia that indicate, to a user, specific actions used in editing content, e.g. a “delete” button.

In a specific implementation, the hotspot action management engine 520 functions to associate actions that are carried out during execution of a key frame when a hotspot is activated. For example, the hotspot management engine 520 can associate an action that a key frame should be executed backwards when a hotspot is activated, such that content displayed when executing the key frame is displayed in reverse. Similarly, the hotspot management engine 520 can associate an action that a key frame should be executed at an increased speed to which it is normally executes when a hotspot is activated, such that content displayed when executing the key frame is displayed at an increased speed after the hotspot is activated. In another example, the hotspot management engine 520 can associate an action that execution of a key frame should be stopped when a hotspot is activated, such that content displayed when executing the key frame is paused after the hotspot is activated. The hotspot action management engine 520 can associate actions that are carried out during execution of a key frame when a hotspot is activated based on presentation rules of source content represented by the key frame. For example, if presentation rules of source content represented in a key frame, specify that a user can modify the source content, then the hotspot action management engine 520 can associate actions used in editing source content, e.g. deleting text, with hotspots included in the key frame. Similarly, if presentation rules of source content represented in a key frame, specify that a user is not allowed to modify the source content, then the hotspot action management engine 520 can determine not to associate actions used in editing source content, e.g. deleting text, with hotspots included in the key frame.

In an example of operation of the example system shown in FIG. 5, the key frame generation engine 512 generates key frames according to presentation rules of source content from which universal format presentation content stored in the universal format presentation content datastore 504 is generated. In the example of operation of the example system shown in FIG. 5, the key frame relation engine 514 determines the relation between key frames generated by the key frame generation engine 512. Further in the example of operation of the example system shown in FIG. 5, the key frame action management engine 516 includes actions into a key frame generated by the key frame generation engine 512 that indicate what key frame should be executed after the key frame based on key frame relations determined by the key frame relation engine 514. Additionally, in the example of operation of the example system shown in FIG. 5, the hotspot placement engine 518 can place hotspots in the key frame based on presentation rules for the source content represented in the key frame. In the example of operation of the example system shown in FIG. 5, the hotspot action management engine 520 can associate actions with a hotspot that are performed when a user executes the hotspot during execution of the key frame.

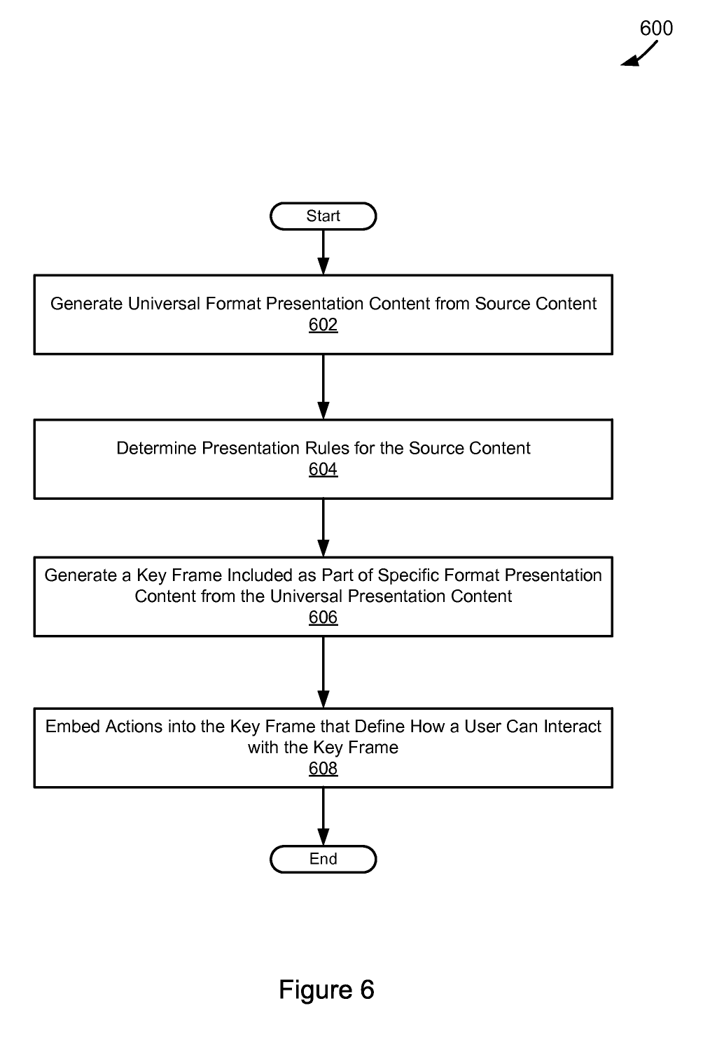

FIG. 6 depicts a flowchart 600 of an example of a method for generating specific format presentation content that includes key frames form source content. The flowchart 600 begins at module 602, where universal format presentation content is generated from source content. In generating universal format presentation content, source content can be grouped into subsets of content. Further in generating universal format presentation content, one or a plurality of content layers can be created for each subset of content to include the source content included in the subset of content. For example, if a subset of content includes a video file, then one or a plurality of content layers corresponding to the subset of content can be created to include the video file or portions of the video file.

The flowchart 600 continues to module 604, where presentation rules for the source content are determined. Presentation rules for the source content can define how a user can interacts with source content or specific format presentation content that includes the source content. Depending upon implementation-specific or other considerations, presentation rules can be determined directly from the source content and/or the universal format presentation content generated from the source content. Further depending upon implementation-specific or other considerations, presentation rules can be determined from a creator or administrator of the source content.

The flowchart 600 continues to module 606, where a key frame is generated that is included as part of specific format presentation content from the universal format presentation content. A key frame generated at module 606 can specify how content is presented. For example a key frame can specify to display a first video first and a second video after the first video is displayed. Depending upon implementation-specific or other considerations, a key frame generated at module 606, can be generated based on presentation rules determined for the source content at module 604. For example, if presentation rules specify that specific portions of source content should be grouped into a subset of content, then a key frame can be generated that includes the portions of source content that the presentation rules specify should be grouped into a subset of content. Further depending upon implementation-specific or other considerations, a key frame can be generated at module 606 based on subsets of content in which the source content or the universal format presentation content are grouped. For example, source content or universal format presentation content can be grouped into a subset of content if content included in the source content or universal format presentation content is related, e.g. is part of the same sequence of content or is of the same type of content. In generating a key frame at module 606 based on subsets of content in which the source content or the universal format presentation content are grouped, a key frame can be generated to include all or a portion of either or both the source content or the universal format presentation content included in the subset of content.

The flowchart 600 continues to module 608, where actions are embedded into the key frame that define how a user can interact with the key frame. Actions embedded into the key frame can include how content include in the key frame can be presented to a user, and/or modified by a user. Depending upon implementation-specific or other considerations, actions embedded into the key frame can be in accordance with the presentation rules for the source content determined at module 604. Actions embedded into a key frame can specify how a user can interact with content represented by the key frame. For example, actions can specify that content in the key frame should be treated as read-only, thereby not allowing a user to edit the content. Actions embedded into a key frame can also specify a next key frame to execute after the key frame is executed.

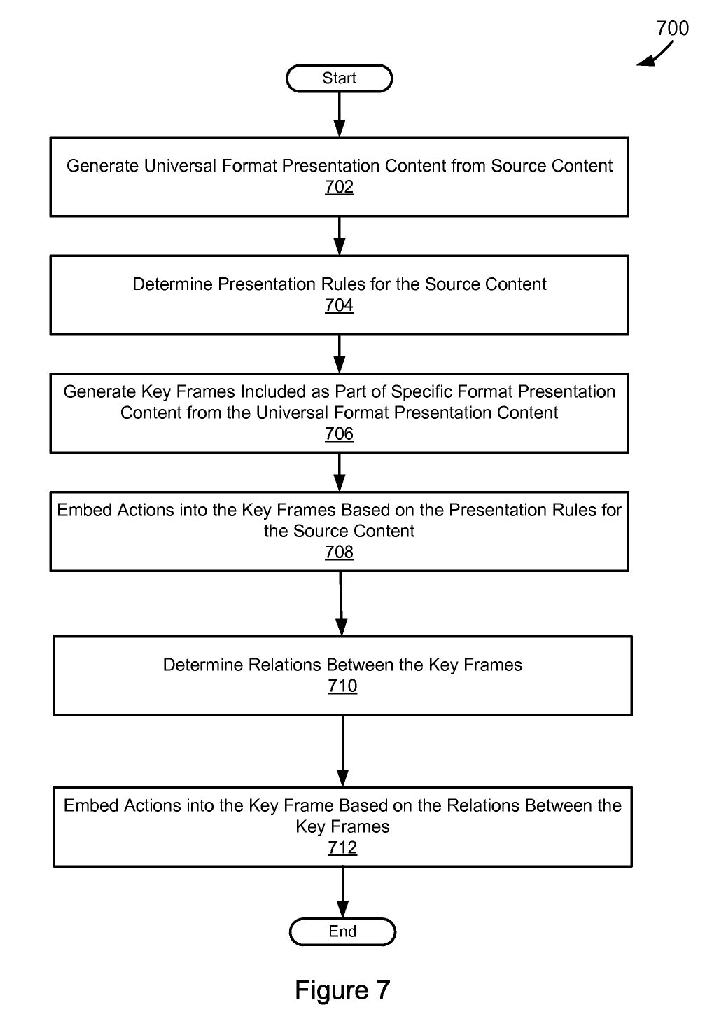

FIG. 7 depicts a flowchart 700 of another example of a method for generating key frames included as part of specific format presentation content from universal format presentation content. The flowchart 700 begins at module 702, where universal format presentation content is generated from source content. In generating universal format presentation content, source content can be grouped into subsets of content. Further in generating universal format presentation content, one or a plurality of content layers can be created for each subset of content to include the source content included in the subset of content. For example, if a subset of content includes a video file, then one or a plurality of content layers corresponding to the subset of content can be created to include the video file or portions of the video file.

The flowchart 700 continues to module 704, where presentation rules for the source content are determined. Presentation rules for the source content can define how a user can interacts with source content or specific format presentation content that includes the source content. Depending upon implementation-specific or other considerations, presentation rules can be determined directly from the source content and/or the universal format presentation content generated from the source content. Further depending upon implementation-specific or other considerations, presentation rules can be determined from a creator or administrator of the source content.

The flowchart 700 continues to module 706, where key frames, included as part of specific format presentation content, are generated from the universal format presentation content. A key frame generated at module 706 can specify how content is presented. For example a key frame can specify to display a first video first and a second video after the first video is displayed. Depending upon implementation-specific or other considerations, a key frame generated at module 706, can be generated based on presentation rules determined for the source content at module 704. For example, if presentation rules specify that specific portions of source content should be grouped into a subset of content, then a key frame can be generated that includes the portions of source content that the presentation rules specify should be grouped into a subset of content. Further depending upon implementation-specific or other considerations, a key frame can be generated at module 706 based on subsets of content in which the source content or the universal format presentation content are grouped. For example, source content or universal format presentation content can be grouped into a subset of content if content included in the source content or universal format presentation content is related, e.g. is part of the same sequence of content or is of the same type of content. In generating a key frame at module 706 based on subsets of content in which the source content or the universal format presentation content are grouped, a key frame can be generated to include all or a portion of either or both the source content or the universal format presentation content included in the subset of content.

The flowchart 700 continues to module 708, where actions are embedded into the key frames based on the presentation rules for the source content. Actions embedded into the key frame based on the presentation rules for the source content can be used to manage how a user interacts with content included in the key frames. For example, if presentation rules specify that specific content included in the key frames is read-only, then an action embedded into the key frames can limit or prevent a user from editing the content. Similarly, if presentation rules specify that content cannot be deleted from the key frames, then an action embedded into the key frames can prevent a user from deleting the content.

The flowchart continues to module 710, where relations between key frames are determined. Relations between the key frames determined at module 710 can include that a second key frame should be executed after a first key frame. Additionally, relations between the key frames determined at module 710 can include a likelihood that a user will want to execute a second key frame after a first key frame is executed. Depending upon implementation-specific or other considerations, relations between the key frames can be determined at module 710 based on presentation rules of source content that is included in the key frames. For example, if presentation rules specify that a first subset of source content included in a first should be displayed after a second subset of source content, then the key frame relation engine 514 can determine that a key frame related to the second subset of source content should be executed after a key frame related to the first subset of source content is executed. Further depending upon implementation-specific or other considerations, a relation of key frames can be determined at module 710 based on a specific probability that a first key frame will be executed after a second key frame. A specific probability that a first key frame will be executed after a second key frame can be determined based on whether or the amount of times that users during previous sessions interacted with content included in the second key frame after interacting with content included in the first key frame.

The flowchart 700 continues to module 712 where actions are embedded into the key frames based on the relations between the key frames determined at module 710. Depending upon implementation-specific or other considerations, an action can be embedded into a first key frame of the key frames that specifies to execute a second key frame of the key frames if it is determined that the first key frame and the second key frame are related. For example, if it is determined that a first key frame and a second key frame of the key frames are related, as product presentation rules specify that the second key frame should be executed after the first key frame, then an action can be embedded in either or both the first key and the second key frame that specifies to execute the second key frame after the first key frame is executed, at least partially. In another example, if it is determined that a first key frame and a second key frame of the key frames are related, as there is a specific probability that the second key frame will be executed after the first key frame is executed, then an action can be embedded in either or both the first key frame and the second key frame that specifies to execute the second after the first key frame is executed, at least partially.

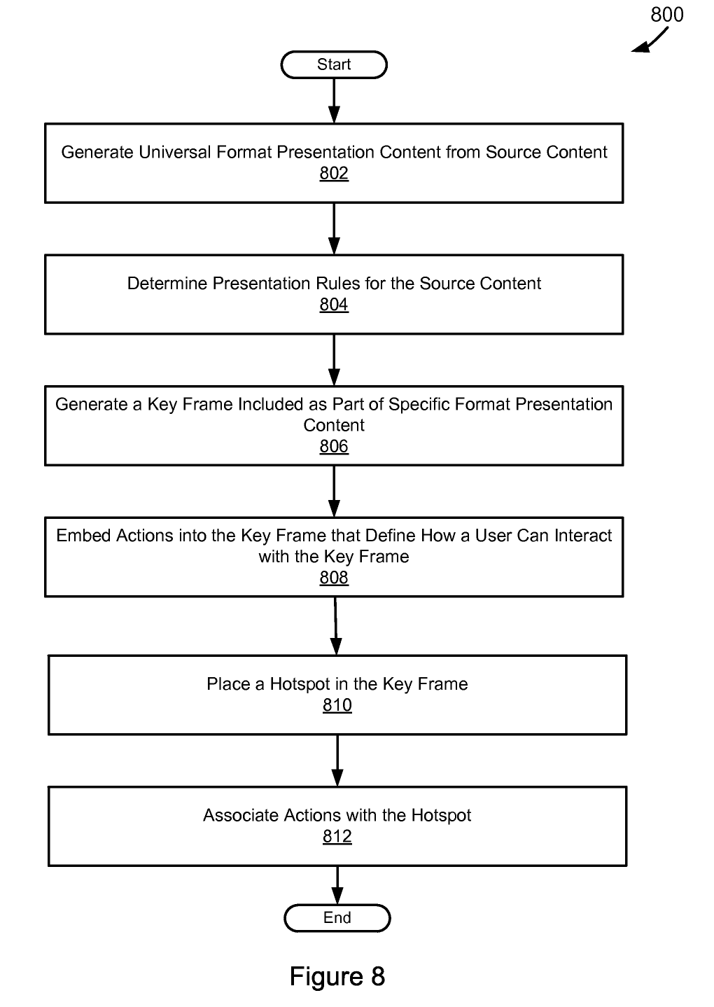

FIG. 8 depicts a flowchart 800 of an example of a method of generating key frames that include hotspots, as part of specific format presentation content, from universal format presentation content. The flowchart 800 begins at module 802, where universal format presentation content is generated from source content. In generating universal format presentation content, source content can be grouped into subsets of content. Further in generating universal format presentation content, one or a plurality of content layers can be created for each subset of content to include the source content included in the subset of content. For example, if a subset of content includes a video file, then one or a plurality of content layers corresponding to the subset of content can be created to include the video file or portions of the video file.

The flowchart 800 continues to module 804, where presentation rules for the source content are determined. Presentation rules for the source content can define how a user can interacts with source content or specific format presentation content that includes the source content. Depending upon implementation-specific or other considerations, presentation rules can be determined directly from the source content and/or the universal format presentation content generated from the source content. Further depending upon implementation-specific or other considerations, presentation rules can be determined from a creator or administrator of the source content.

The flowchart 800 continues to module 806, where a key frame is generated that is included as part of specific format presentation content from the universal format presentation content. A key frame generated at module 806 can specify how content is presented. For example a key frame can specify to display a first video first and a second video after the first video is displayed. Depending upon implementation-specific or other considerations, a key frame generated at module 806, can be generated based on presentation rules determined for the source content at module 804. For example, if presentation rules specify that specific portions of source content should be grouped into a subset of content, then a key frame can be generated that includes the portions of source content that the presentation rules specify should be grouped into a subset of content. Further depending upon implementation-specific or other considerations, a key frame can be generated at module 806 based on subsets of content in which the source content or the universal format presentation content are grouped. For example, source content or universal format presentation content can be grouped into a subset of content if content included in the source content or universal format presentation content is related, e.g. is part of the same sequence of content or is of the same type of content. In generating a key frame at module 806 based on subsets of content in which the source content or the universal format presentation content are grouped, a key frame can be generated to include all or a portion of either or both the source content or the universal format presentation content included in the subset of content.

The flowchart 800 continues to module 808, where actions are embedded into the key frame that define how a user can interact with the key frame. Actions embedded into the key frame can include how content include in the key frame can be presented to a user, and/or modified by a user. Depending upon implementation-specific or other considerations, actions embedded into the key frame can be in accordance with the presentation rules for the source content determined at module 804. Actions embedded into a key frame can specify how a user can interact with content represented by the key frame. For example, actions can specify that content in the key frame should be treated as read-only, thereby not allowing a user to edit the content. Actions embedded into a key frame can also specify a next key frame to execute after the key frame is executed.

The flowchart 800 continues to module 810, where hotspots are positioned in the key frame. Hotspots included in key frames, can be visual indicia that are used in interacting with content represented by the key frames. In use in interacting with content, hotspots can have actions associated with them that are used to manipulate execution of key frames in order to interact with content represented by the key frame. For example, a hotspot can be used to speed up the rate at which a key frame is executed in order to display content represented by the key frame faster. Depending upon implementation-specific or other considerations, hotspots can be positioned in key frames based on the presentation rules for the source content that is in the key frame. For example, if presentation rules specify that a hotspot can only be placed in a specific corner of a key frame, then a hotspot can be placed in the specific corner of the key frame. Additionally, specific hotspots with specific visual indicia can be placed in the key frame or the content of the key frame based on the presentation rules. For example, if the presentation rules for the source content specify that a hotspot represented by a circle should be placed a key frame, then a hotspot represented by a circle can be placed in the key frame. In another example, if presentation rules for source content can specify that source content represented in a key frame can be edited, then a hotspot can be placed in the key frame or the content of the key frame that includes indicia that indicate, to a user, specific actions used in editing content, e.g. a “delete” button.

The flowchart 800 continues to module 812, where actions are associated with the hotspot. Actions associated with the hotspot can be actions that are carried out in providing functionalities for a user when interacting with content included in the key frame. For example, an action can be associated with the hotspot that indicates that the key frame should be executed backwards when the hotspot is activated, such that content displayed when executing the key frame is displayed in reverse. In another example, an action can be associated with the hotspot indicating that execution of the key frame should be stopped when the hotspot is activated, such that content displayed when executing the key frame is paused after the hotspot is activated. Depending upon implementation-specific or other considerations, actions can be associated with the hotspot based on the presentation rules of the source content included in the key frame. For example, if presentation rules of the source content in the key frame specify that a user can modify the source content, then actions used in editing source content, e.g. deleting text, can be associated with the hotspot.

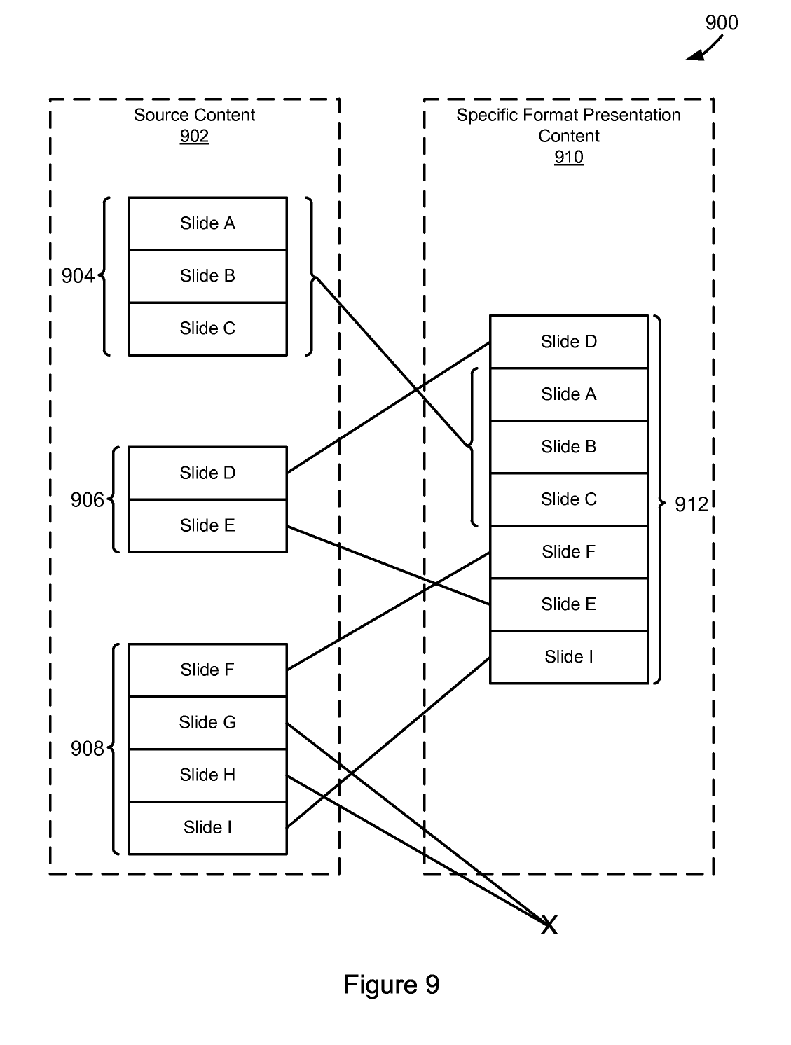

FIG. 9 depicts a diagram 900 of an example of source content that is converted to specific format presentation content according to presentation rules for the source content. In FIG. 9 the source content 902 is shown to be slides of a presentation, however, depending upon implementation-specific or other considerations, the source content can include applicable presentation content, such as videos or images.

In the example shown in FIG. 9, the source content 902 includes mandatory order slides 904, must include slides 906, and optional slides 908. What slides are mandatory order slides 904, must include slides 906, and optional slides 908, can be indicated by presentation conditions for the source content 902. A mandatory order in which the mandatory order slides 904 are to be presented can also be included as presentation conditions for the source content 902.

The mandatory order slides 904 include Slide A, Slide B, and Slide C. The mandatory order slides 904 are slides that must be presented in the order in which they exist as source content 902. Specifically, Slide A must be shown first, then Slide B, followed by Slide C. Depending upon implementation-specific or other considerations, the mandatory order slides 904 can be included in specific format presentation content in any position, so that they are presented at any time during presentation of the specific format presentation content, as long as they are presented in the mandatory order in which they are arranged as source content 902. For example, the mandatory order slides 904 can be presented last in the presentation of specific format presentation content, as long as Slide A is presented first in presenting the mandatory order slides, after which Slide B is presented, followed by Slide C.

The must include slides 906 include Slide D and Slide E. The must include slides 906 include slides that must be presented during presentation of specific format presentation content. The must include slides 906 can be presented in any order in the presentation of slides as specific format presentation content, as long as the must include slides are not presented between the presentation of the mandatory order slides 904. For example, Slide D can be presented at any time during the presentation of slides as specific format presentation content, as long as Slide D is not presented between the presentation of either Slide A and Slide B, or Slide B and Slide C.

The optional slides 908 include Slide F, Slide G, Slide H, and Slide I. The optional slides 908 include slides that can be presented during the presentation of specific format presentation content but do not have to be presented during the presentation of specific format presentation content. In the example shown in FIG. 9, Slide F and Slide I are presented during the presentation of specific format presentation content, while Slide G and Slide H are not presented during the presentation of the specific format presentation content. The optional slides 908 can be presented in any order in the presentation of slides as specific format presentation content, as long as the optional slides are not presented between the presentation of the mandatory order slides 904. For example, Slide F can be presented at any time during the presentation of slides as specific format presentation content, as long as Slide F is not presented between the presentation of either Slide A and Slide B, or Slide B and Slide C.

The example shown in FIG. 9 includes specific format presentation content 910 that is generated from the source content 902. The specific format presentation content 910 can be translated from universal format presentation content according to applicable techniques, including techniques described in this paper. Universal format presentation content from which the specific format presentation content 910 can be translated can be generated from the source content 902 according to applicable techniques, including techniques described in this paper. Depending upon implementation-specific or other considerations, the specific format presentation content 910 can include one or a plurality of key frames that are used to present slides of the specific format presentation content 910.

In the example shown in FIG. 9, the specific format presentation content 910 includes a presentation order 912 which specifies an order in which slides in the specific format presentation content 910 are presented. Slides are added to organized in the presentation order 912 according to whether the slides are mandatory order slides 904, must include slides 906, and optional slides 908. Specifically, the mandatory order slides 904 are included in the presentation order in the order in the mandatory order specified by presentation rules for the source content 902. Additionally, the must include slides 906 are included in the presentation order 912 and are organized in the presentation order 912 such that they are not presented in between slides that are mandatory order slides. Optional slides 908 including Slide F and Slide I are included in the presentation order 912 and are organized in the presentation order 912 such that they are not presented in between slides that are mandatory order slides. In the example shown in FIG. 9 the presentation order 912 of the specific format presentation content 910 includes must include Slide D first, then mandatory order Slide A, followed by mandatory order Slides B and C. Further in the example shown in FIG. 9, after mandatory order Slide B, the presentation order 912 includes optional Slide F, then must include Slide E, followed by optional Slide I. In the example shown in FIG. 9, optional Slides G and H are not included in the presentation order 912.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

We claim:

1. A method comprising:
generating universal format presentation content from source content;
determining presentation rules for the source content;
generating specific format presentation content from the universal format presentation content comprising:
generating at least one key frame of the specific format presentation content from the universal presentation content, the at least one key frame used for presenting content in the at least one key frame;
embedding at least one action specifying how a user can interact with the content in the at least one key frame based on the presentation rules for the source content.

2. The method of claim 1, wherein generating the universal format presentation content from the source content further comprises:
determining a first subset of source content and a second subset of source content in which the source content is grouped;
adding content in the first subset of source content to a first content layer included as part of the universal format presentation content and content in the second subset of source content into a second content layer as part of the universal format presentation content.

3. The method of claim 2, generating the at least one key frame from the universal presentation content further comprises:
generating a first key frame of the specific format presentation content that includes content in the first content layer, the first key frame used for presenting the content in the first content layer;
generating a second key frame of the specific format presentation content that includes content in the second content layer, the second key frame used for presenting the content in the second content layer.

4. The method of claim 2, wherein the first subset of source content and the second subset of source content is determined using the presentation rules for the source content.

5. The method of claim 3, further comprising:
determining a relation between the first key frame and the second key frame;
embedding an action into the second key frame specifying to execute the second key frame after the first key frame is executed if it is determined that the first key frame and the second key frame are related.

6. The method of claim 5, wherein it is determined if the first key frame and the second key frame are related if the presentation rules for the source content specify that content in the second key frame should be presented after content in the first key frame is presented.

7. The method of claim 1, further comprising placing a hotspot in the at least one key frame, the hotspot used to control interaction by a user with the content in the at least one key frame.

8. The method of claim 7, wherein the hotspot is placed in the at least one key frame according to presentation rules of the source content.

9. The method of claim 7, further comprising associating an action with the hotspot based on the presentation rules for the source content, the action associated with the hotspot defining how the at least one key frame is executed when the hotspot is activated.

10. The method of claim 8, wherein the action associated with the hotspot provides functionalities to the user in editing the content in the at least one key frame when the hotspot is activated.

11. A system comprising:
a universal format presentation content generation system configured to:
generate universal format presentation content from source content;
determine presentation rules for the source content;
a rules based universal format presentation content translation system configured to generate specific format presentation content from the universal format presentation content, the rules based universal format presentation content translation system further configured to:
generate at least one key frame of the specific format presentation content from the universal presentation content, the at least one key frame used for presenting content in the at least one key frame;
embed at least one action specifying how a user can interact with the content in the at least one key frame based on the presentation rules for the source content.

12. The system of claim 11, wherein the universal format presentation content generation system is further configured to:
determine a first subset of source content and a second subset of source content in which the source content is grouped;
add content in the first subset of source content to a first content layer included as part of the universal format presentation content and content in the second subset of source content into a second content layer as part of the universal format presentation content.

13. The system of claim 12, wherein in generating the at least one key frame from the universal presentation content, the rules based universal format presentation content translation system is further configured to:
generate a first key frame of the specific format presentation content that includes content in the first content layer, the first key frame used for presenting the content in the first content layer;
generate a second key frame of the specific format presentation content that includes content in the second content layer, the second key frame used for presenting the content in the second content layer.

14. The system of claim 11, wherein the universal format presentation content generation system determines the first subset of source content and the second subset of source content using the presentation rules for the source content.

15. The system of claim 13, wherein the rules based universal format presentation content translation system is further configured to:
determine a relation between the first key frame and the second key frame;
embed an action into the second key frame specifying to execute the second key frame after the first key frame is executed if it is determined that the first key frame and the second key frame are related.

16. The system of claim 15, wherein the rules based universal format presentation content translation system is further configured to determine that the first key frame and the second key frame are related if the presentation rules for the source content specify that content in the second key frame should be presented after content in the first key frame is presented.

17. The system of claim 11, further comprising a hotspot placement engine configured to place a hotspot in the at least one key frame, the hotspot used to control interaction by a user with the content in the at least one key frame.

18. The system of claim 17, wherein the hotspot placement engine is configured to place the hotspot in the at least one key frame according to presentation rules of the source content.

19. The system of claim 17, further comprising a hotspot action management engine configured to associate an action with the hotspot based on the presentation rules for the source content, the action associated with the hotspot defining how the at least one key frame is executed when the hotspot is activated.

20. The system of claim 19, wherein the action associated with the hotspot provides functionalities to the user in editing the content in the at least one key frame when the hotspot is activated.

21. A system comprising:
means for generating universal format presentation content from source content;
means for determining presentation rules for the source content;
means for generating specific format presentation content from the universal format presentation content further comprising:
means for generating at least one key frame of the specific format presentation content from the universal presentation content, the at least one key frame used for presenting content in the at least one key frame;
means for embedding at least one action specifying how a user can interact with the content in the at least one key frame based on the presentation rules for the source content.
